(19) United States
(12) Patent Application Publication
(10) Pub. No.: US 2007/0296862 A1
(43) Pub. Date: Dec. 27, 2007

(54) Television receiving apparatus

(75) Inventor: Munehiro Terada, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/636,615

(22) Filed: Dec. 11, 2006

(30) Foreign Application Priority Data
Jun. 26, 2006 (JP) 2006-175890

(51) Int. Cl. H04N 3/27; H04N 5/46

(52) U.S. Cl. 348/558; 348/554

(57) ABSTRACT

A television receiving apparatus (1) of the invention includes a video signal-switching circuit (11), an input signal-detecting circuit (12), a control circuit (13), a video signal-processing circuit (14), a memory (15), and a display device (16). When the input signal-detecting circuit (12) judges that a received video signal is one obtained from an analog broadcasting, the control circuit (13) issues an instruction to a kind-of-video signal-detecting circuit (14a) to change a detection condition for the video signal to another one which is not so strict as the detection condition is when the input signal-detecting circuit (12) judges that the received video signal is one obtained from an digital broadcasting.

The present application is based on Japanese patent application No. 2006-175890, the entire contents of which are incorporated herein by reference.

### BACKGROUND

1. Field

One embodiment of the invention relates to a television receiving apparatus, and more particularly to a television receiving apparatus which is capable of causing misdetection of a kind of a video signal in 2:3/2:2 pull-down processing to hardly occur.

2. Description of the Related Art

As being typified by reception of a television broadcasting, reproduction of a sound and an image from a video tape or DVD, there are various methods of viewing and listening to a sound and an image by using a television receiving apparatus. In addition, there are rich kinds of images. For example, it is possible to view and listen to a sound and an image obtained from a film using the television receiving apparatus by utilizing suitable one of the methods described above.

However, normally, images obtained from a theater film are made from 24 frames per one second, whereas images displayed on the television receiving apparatus, complying with the NTSC system, which is used in Japan, etc., are made from 30 frames (2 fields per one frame) per one second. For this reason, the number of frames per one second in the film, and the number of frames per one second displayed by the television receiving apparatus do not agree with each other. When this situation is unsettled, any of the images obtained from the films cannot be displayed on the television receiving apparatus.

In order to cope with such a problem, 2:3 pull-down processing is executed in a phase of production of the video signal to convert the images having 24 frames per one second into the images having 30 frames per one second, which results in that it is possible to view and listen to a sound and an image obtained from the film by using the television receiving apparatus. On the other hand, in the television receiving apparatus complying with the PAL system, 2:2 pull-down processing is executed, which similarly results in that the image obtained from the film can be displayed on the television receiving apparatus.

Moreover, when the video signal for which the 2:3 pull-down processing or the like is previously executed in the phase of its production in advance is received and is then subjected to IP conversion, reverse 2:3 pull-down processing must be executed. In order to attain this, the television receiving apparatus has a function of executing the reverse 2:3 pull-down processing.

However, the image displayed on the television receiving apparatus is not limited to one obtained from the film, and thus the various images are displayed on the television receiving apparatus. For this reason, the different kinds of video signals such as the video signal for which the reverse 2:3 pull-down processing or the like must be executed, and the video signal for which such processing must not be executed may mixedly exist. In such a case, it is necessary to perform the switching relating to whether or not the reverse 2:3 pull-down processing is executed.

With regard to the switching relating to whether or not the reverse 2:3 pull-down processing is executed, there has been known a television receiving apparatus in which a kind of a received video signal is automatically detected to be judged. This television receiving apparatus, for example, is disclosed in the Japanese Patent Kokai No. 2005-26885.

However, according to the television receiving apparatus disclosed in the Japanese Patent Kokai No. 2005-26885, when a kind of a received video signal is automatically detected, it is feared that discrimination of the fields becomes difficult and the misdetection is caused accordingly because the noise is superimposed on the analog signal, if the video signal concerned is an analog signal. As a result, the reverse 2:3 pull-down processing is executed for the image for which the 2:3 pull-down processing is not executed in some cases. Thus, “dropping frames” or “aliasing” is generated to degrade the image quality.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view showing an exterior appearance of an image receiving system including a television receiving apparatus according to the invention;

FIG. 2 is an exemplary block diagram showing an internal configuration of a television receiving apparatus according to a first embodiment of the invention;

FIGS. 3A and 3B are respectively exemplary schematic diagrams showing an example of processing when an image corresponding to a normal video signal complying with an interlace system is displayed;

FIG. 4 is an exemplary schematic diagram showing an example of 2:3 pull-down processing and reverse 2:3 pull-down processing;

FIG. 5 is an exemplary schematic diagram showing an example when the reverse 2:3 pull-down processing is executed for a video signal for which the 2:3 pull-down processing is not executed;

FIGS. 6A and 6B are respectively exemplary schematic diagrams showing a situation in which a judgment relating to whether or not the 2:3 pull-down processing is executed for a signal in advance is made for a video signal obtained from a digital broadcasting;

FIGS. 6C and 6D are respectively exemplary schematic diagrams showing a situation in which a judgment relating to whether or not the 2:3 pull-down processing is executed for a signal in advance is made for a video signal obtained from an analog broadcasting;

FIG. 7 is an exemplary flow chart showing an operation when the television receiving apparatus according to the first embodiment of the invention receives a video signal and executes video signal processing for the received video signal;

FIG. 8 is an exemplary block diagram showing an internal configuration of a television receiving apparatus according to a second embodiment of the invention;

FIGS. 9A and 9B are respectively schematic diagrams showing display examples of an image selection menu in an OSD selection menu of the television receiving apparatus according to the second embodiment of the invention; and

FIG. 10 is an exemplary flow chart showing an operation when the television receiving apparatus according to the second embodiment of the invention receives a video signal and executes video signal processing for the received video signal.

### DETAILED DESCRIPTION OF PREFERRED EMBODIMENTS

Various embodiments according to the invention will be described hereinafter with reference to the accompanying drawings. In general, according to one embodiment of the invention, there is provided a television receiving apparatus, including: a receiving portion for receiving a video signal; a first judging portion for judging whether the video signal is an analog signal or a digital signal; a second judging portion for judging whether the video signal is a signal for which 2:3 pull-down processing is executed; and a control portion for changing a setting for a judgment condition in the second judging portion in accordance with a judgment result obtained from the first judging portion.

In addition, according to a further embodiment of the invention, there is provided a television receiving apparatus, including: a receiving portion for receiving a video signal; a first judging portion for judging whether the video signal is an analog signal or a digital signal; a second judging portion for judging whether the video signal is a signal for which 2:3 pull-down processing is executed; a video signal-converting portion for, when the second judging portion judges that the video signal is a signal for which the 2:3 pull-down processing is executed, executing reverse 2:3 pull-down processing for the video signal; and a control portion for changing a setting for a judgment condition in the second judging portion in accordance with a judgment result obtained from the first judging portion.

According to the television receiving apparatus of the invention, the setting for the detection condition under which a kind of the video signal is detected can be changed in accordance with the result on the judgment relating to whether the video signal is obtained from the analog broadcasting or the digital broadcasting. As a result, the misdetection due to the judgment relating to whether or not the video signal is a signal for which the 2:3 pull-down processing is executed can be made to be hardly caused.

In addition, according to a still further embodiment of the invention, there is provided a television receiving apparatus, including: a receiving portion for receiving a video signal; a first judging portion for judging whether the video signal is an analog signal or a digital signal; a second judging portion for judging whether the video signal is a signal for which 2:3 pull-down processing is executed; an image quality-adjusting portion for performing display adjustment for an image quality in accordance with selection made by a user; and a control portion for changing a setting for a judgment condition in the second judging portion in accordance with a judgment result obtained from the first judging portion and the display adjustment for an image quality made by the image quality-adjusting portion.

According to the television receiving apparatus of the invention, the setting for the selection condition under which a kind of the video signal is detected can be changed in accordance with the selection made by the user. As a result, the misdetection due to the judgment relating to whether or not the video signal is a signal for which the 2:3 pull-down processing is executed can be made to be hardly caused.

According to the invention, the misdetection due to the judgment relating to whether or not the inputted video signal is a signal for which the 2:3 pull-down processing is executed can be prevented for the inputted video signal, and thus the image quality can be made to be hardly degraded.

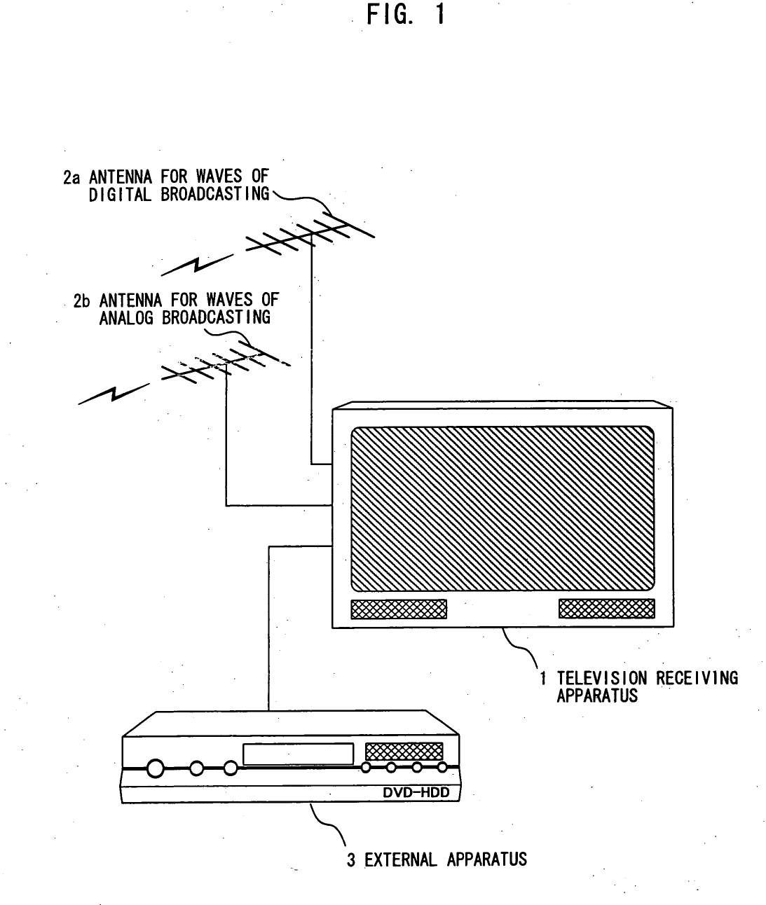

First and second embodiments of the invention will be described in detail hereinafter with reference to FIGS. 1 to 10.

### First Embodiment

### (Construction of Image Receiving System)

FIG. 1 is a schematic view showing an exterior appearance of an image receiving apparatus including a television receiving apparatus according to the invention.

The image receiving system includes a television receiving apparatus 1 according to the invention, a digital antenna 2a and an analog antenna 2b for receiving television broadcasting waves, respectively, and an external apparatus 3.

The television receiving apparatus 1 receives a television broadcasting wave transmitted from a broadcasting station, and displays a television image corresponding to a video signal contained in the television broadcasting wave thus received.

The digital antenna 2a receives therethrough a wave relating to a digital broadcasting of the broadcasting waves. The analog antenna 2b receives therethrough a wave relating to an analog broadcasting of the broadcasting waves. Here, both the digital antenna 2a and the analog antenna 2b are illustrated in the form of separate antennas in FIG. 1. However, one antenna may also be used which receives therethrough the waves relating to both the digital broadcasting and the analog broadcasting. In addition, although an example of a Yagi antenna for a ground wave broadcasting is illustrated as the antenna in FIG. 1, a parabolic antenna for a satellite broadcasting may also be used instead of the Yagi antenna, or an antenna having functions of both the Yagi antenna and the parabolic antenna may also be used instead thereof.

### (Configuration of Television Receiving Apparatus)

The television receiving apparatus according to the invention is one which is capable of changing a setting for a detection condition when a kind of an image corresponding to the inputted video signal is automatically detected to suitable one. In relation thereto, two kinds of methods of changing a setting for a detection condition are proposed herein. Then, television receiving apparatuses according to first and second embodiments of the invention will be described in detail hereinafter with reference to the accompanying drawings, respectively.

The television receiving apparatus according to the first embodiment of the invention is such that a setting for a detection condition is changed to suitable one depending on a judgment relating to whether an image source is an analog broadcasting, a digital broadcasting, or the external apparatus.

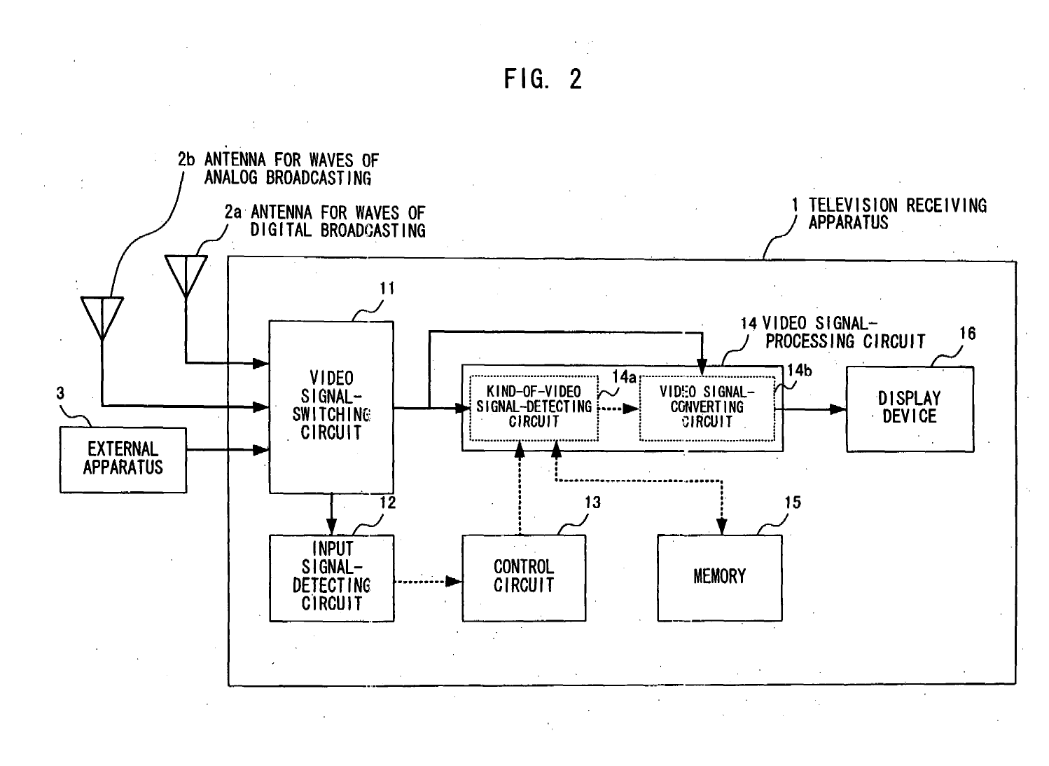

FIG. 2 is a block diagram showing an internal configuration of the television receiving apparatus 1 according to the first embodiment of the invention.

The television receiving apparatus 1 includes a video signal-switching circuit 11, an input signal-detecting circuit 12, a control circuit 13, a video signal-processing circuit 14, a memory 15, and a display device 16. In addition, a digital antenna 2a, an analog antenna 2b, and an external apparatus 3 are connected from the outside to the television receiving apparatus 1.

The television receiving apparatus 1 switches an input destination for a video signal corresponding to an image to be displayed on the display device 16 to any one of the digital antenna 2a, the analog antenna 2b, and the external apparatus 3 which are connected to the video signal-switching circuit 11.

The input signal-detecting circuit 12 detects whether a video signal inputted to the video signal-switching circuit 11 is obtained from a digital broadcasting or the analog broadcasting, or is inputted from the external apparatus 3.

The control circuit 13 performs control in accordance with which a setting for a detection condition under which a kind of a video signal is detected in the video signal-processing circuit 14 is changed based on the detection result obtained from the input signal-detecting circuit 12.

The video signal-processing circuit 14 includes a kind-of-video signal-detecting circuit 14a, and a video signal-converting circuit 14b. The kind-of-video signal-detecting circuit 14a detects a kind of the video signal in accordance with the detection condition set through the control made by the control circuit 13. In addition, the video signal-converting circuit 14b executes IP conversion processing or reverse 2:3 pull-down processing for the video signal inputted to the video signal-processing circuit 14 through the video signal-switching circuit 11 in accordance with the detection result obtained from the kind-of-video signal-detecting circuit 14a.

The memory 15 stores therein data such as a detection condition-setting table which contains therein a plurality of detection conditions for the settings for the detection conditions under suitable one of which the kind-of-video signal-detecting circuit 14a detects a kind of the video signal. The kind-of-video signal-detecting circuit 14a reads out the detection condition corresponding to the setting made through the control by the control circuit 13 from the detection condition-setting table stored in the memory 15, and detects a kind of the video signal under the detection condition thus read out.

The display device 16 displays thereon an image corresponding to the inputted video signal.

When the video signal is inputted to the television receiving apparatus 1 from one input destination selected among the digital antenna 2a, the analog antenna 2b, and the external apparatus 3 in accordance with the switching for the video signal input destination by the video signal-switching circuit 11, the video signal concerned is inputted to each of the input signal-detecting circuit 12 and the video signal-processing circuit 14.

The input signal-detecting circuit 12 detects whether the input destination of the video signal corresponds to the digital antenna 2a, the analog antenna 2b, or the external apparatus 3, and transmits the detection result to the control circuit 13. Thus, the control circuit 13 changes the setting for the detection condition under which a kind of the video signal is detected to suitable one.

When the control circuit 13 changes the setting for the detection condition to suitable one, the video signal-processing circuit 14 detects a kind of the video signal received from the video signal-switching circuit 11 under the detection condition or the like for the setting read out from the memory 15. Also, when detecting that the video signal is one for which the 2:3 pull-down processing is executed in a phase of its production in advance, that is, one corresponding to a film, the video signal-processing circuit 14 executes the reverse 2:3 pull-down processing for the video signal concerned. On the other hand, when detecting that the video signal is one for which no 2:3 pull-down processing is not executed in the phase of its production in advance, the video signal-processing circuit 14 executes the normal IP conversion processing for the video signal concerned.

### (Reverse 2:3 Pull-down Processing)

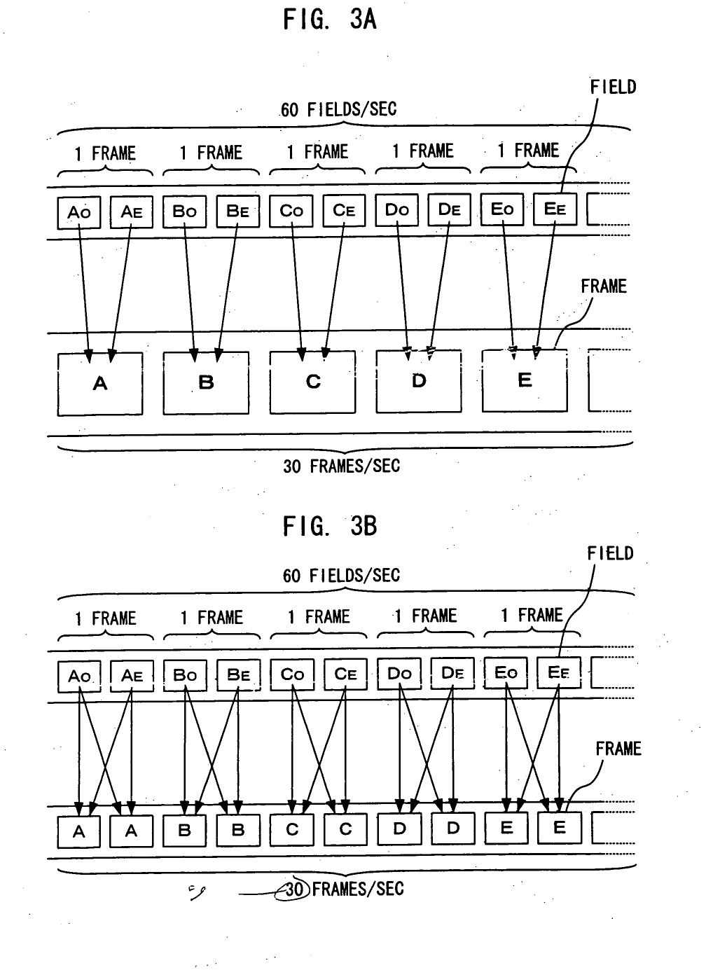

Next, the reverse 2:3 pull-down processing will now be described with reference to FIGS. 3A and 3B to FIG. 5. Note that, although the television receiving apparatus 1 according to the first embodiment of the invention has the same function not only for the reverse 2:3 pull-down processing, but also for the reverse 2:2 pull-down processing, the following description is given by giving, as an example, the reverse 2:3 pull-down processing.

FIGS. 3A and 3B are respectively schematic diagrams showing an example of processing when an image corresponding to the normal video signal complying with the interlace system is displayed.

In the case of the NTSC system utilized in Japan, etc., the vertical scanning frequency of 60 Hz is set for the video signals in the normal television broadcastings except for the films. Thus, the video signal has 60 fields per one second. Moreover, since the skip scanning is performed for the image corresponding to the video signal complying with the interlace system, data which is half that corresponding to the full image can be merely displayed in one field. Therefore, one frame, for instance, a frame “A” is formed by combining the two fields, for instance, fields “A_{O}” and “A_{E}”.

As shown in FIG. 3A, for example, a frame A in a certain image includes a field A_{O} in which odd-numbered scanning lines in the frame A are displayed, and a field A_{E} in which even-numbered scanning lines in the frame A are displayed. In the case of the interlace system, the field A_{O} and the field A_{E} are successively displayed on a screen, thereby displaying the image for one frame.

In addition, in the television receiving apparatus utilizing the progressive system, the full image can be displayed in one frame. Thus, as shown in FIG. 3B, after two kinds of fields each complying with the interlace system are composed, the resulting image is displayed continuously in the two frames. For example, a field A_{O}, in a frame A of a certain image, in which odd-numbered scanning lines are displayed, and a field A_{E}, in the frame A of the certain image, in which even-numbered scanning lines are displayed are composed to produce one frame A, and the resulting one frame A is displayed continuously twice.

On the other hand, since the image obtained from the film has the 24 frames per one second, the television receiving apparatus cannot display thereon the image with the number of frames per one second being held as it is. Thus, in the case of the NTSC system, it is necessary to execute the 2:3 pull-down processing that two fields are produced from a first frame, and three fields are produced from a next frame, and this process is repeatedly carried out.

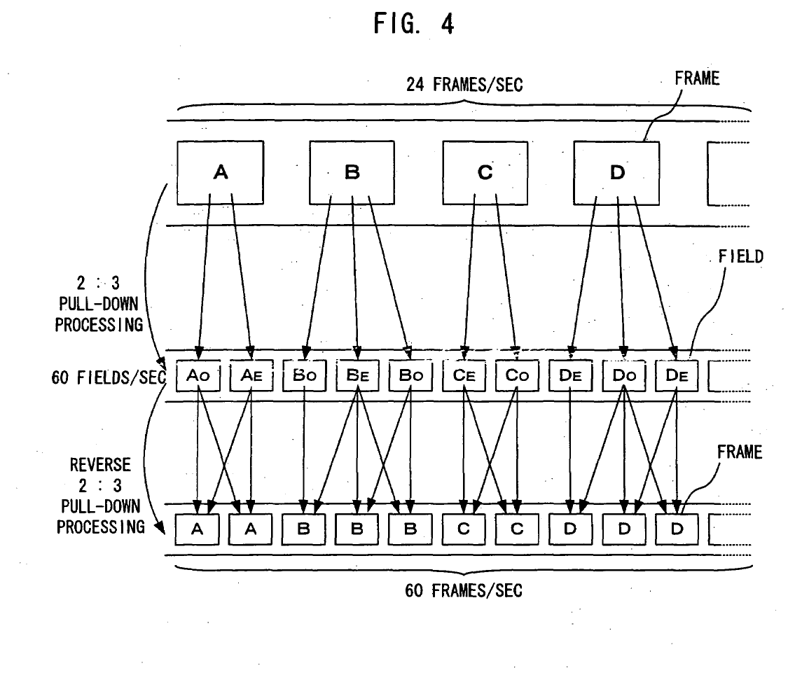

FIG. 4 is a schematic diagram showing examples of the 2:3 pull-down processing and the reverse 2:3 pull-down processing.

Referring to FIG. 4, the execution of the 2:3 pull-down processing for the video signal in the film results in that for example, two fields each complying with the interlace system are obtained from a frame A, and three fields each also complying with the interlace system are obtained from a frame B.

When the image is reproduced from the video signal, thus obtained, complying with the interlace system in accordance with the progressive system, it is necessary to perform the composition through the reverse 2:3 pull-down processing as shown in FIG. 4. That is to say, since the number of fields corresponding to one frame is not necessarily an even number, and thus a portion appears in which the fields in the video signal complying with the interlace system cannot be combined with each other in order on a two-by-two basis, the portion must be adjusted.

The reverse 2:3 pull-down processing must be executed only for the video signal for which the 2:3 pull-down processing is executed in advance. Thus, if the reverse 2:3 pull-down processing is executed for the video signal for which no 2:3 pull-down processing is executed, the image having the so-called “dropping frames” or “aliasing” generated therein is displayed in some cases.

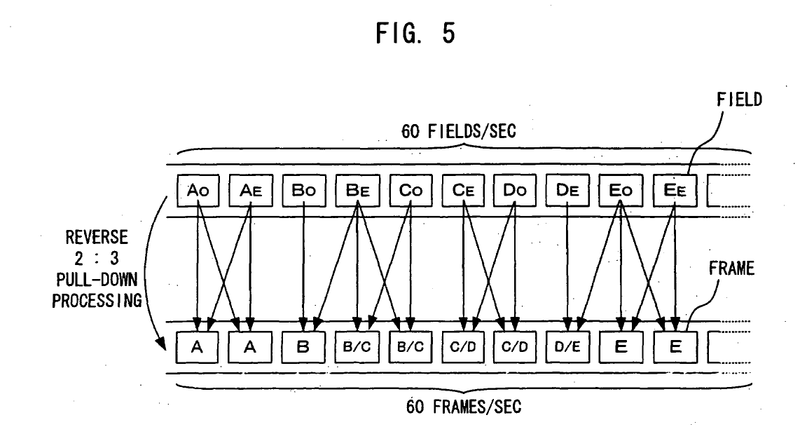

FIG. 5 shows an example in which the reverse 2:3 pull-down processing is executed for the video signal for which no 2:3 pull-down processing is executed.

In this case, there are composed the fields which are generated from the originally different frames, respectively, and which are typified by, for example, a field B_{E}, of a frame B, in which even-numbered scanning lines are displayed and a field C_{O}, of a frame C, in which odd-numbered scanning lines are displayed. As a result, such fields and the fields which are obtained through the composition especially without causing any of problems are generated, which results in that the “dropping frames”, the “aliasing” or the like is caused.

### (Judgment Relating to Whether or not Reverse 2:3 Pull-down Processing is Executed)

In order to prevent the processing as described above from being executed, it is necessary to exactly judge whether or not the inputted video signal is one for which the 2:3 pull-down processing is executed in advance.

In order to carry out this judgment, images corresponding to the fields in which the odd-numbered side or even-numbered side scanning lines are displayed, respectively, are compared with each other, and it is judged in accordance with a change in comparison result whether or not the inputted video signal is one for which the 2:3 pull-down processing is executed in advance.

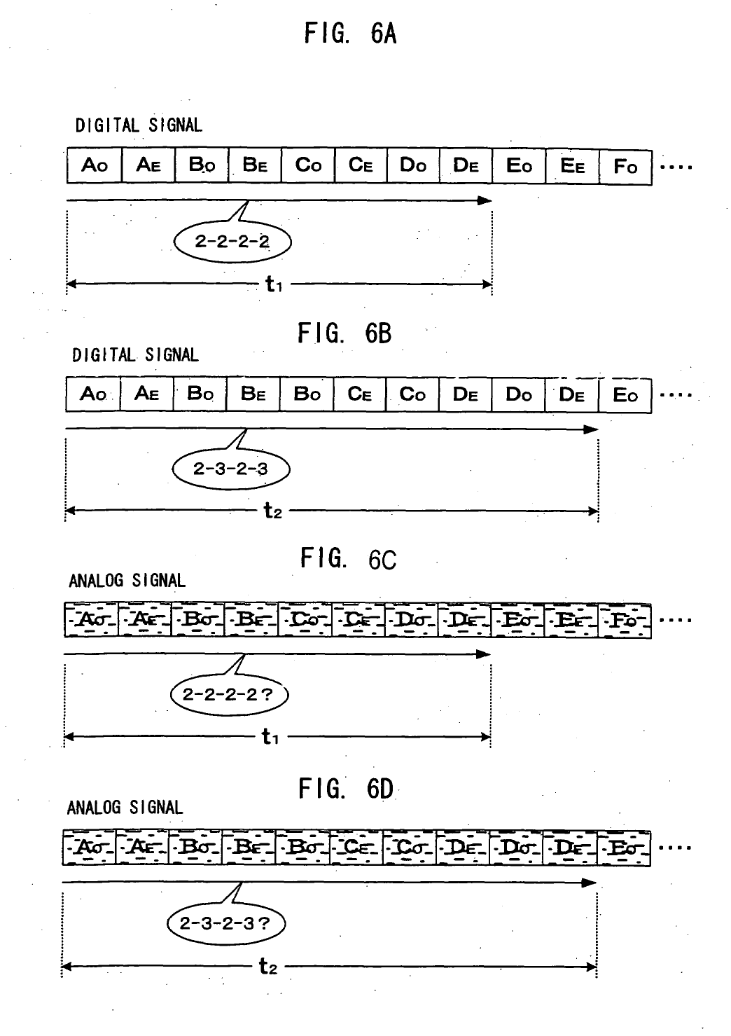

FIGS. 6A and 6B are respectively schematic diagrams showing a situation in which it is judged whether or not the video signal obtained from the digital broadcasting is one for which the 2:3 pull-down processing is executed in advance, and FIGS. 6C and 6D are respectively schematic diagrams showing a situation in which it is judged whether or not the video signal obtained from the analog broadcasting is one for which the 2:3 pull-down processing is executed in advance.

FIG. 6A shows the situation in which it is judged that the video signal obtained from the digital broadcasting is one for which no 2:3 pull-down processing is executed. In the case of the video signal for which no 2:3 pull-down processing is executed, all the signals corresponding to the fields, respectively, are different, respectively.

On the other hand, FIG. 6B shows the situation in which it is judged that the video signal obtained from the digital broadcasting is one for which the 2:3 pull-down processing is executed in advance. In the case of the video signals for which the 2:3 pull-down processing is executed in advance, the same two fields such as two fields B_{O} or two fields D_{E} in FIG. 6B which are the same exist.

Therefore, the preceding field and the subsequent field are compared with each other, and a change between these fields is detected, which results in that it is possible to judge whether or not the inputted video signal is one for which the 2:3 pull-down processing is executed in advance.

For example, referring to FIG. 6A, retrieval for a time period (t1) for 8 fields results in that it is understood that these fields are combined in the form of “2-2-2-2”. Therefore, it is judged that the inputted video signal is one for which no 2:3 pull-down processing is executed. On the other hand, referring to FIG. 6B, retrieval for a time period (t2) for 10 fields results in that it is understood that these fields are combined in the form of “2-3-2-3” because the same two fields, such as the two fields “B_{O}” or the two field “D_{E}”, which are the same fields exist. As a result, it is judged that the inputted video signal is one for which the 2:3 pull-down processing is executed in advance.

When the inputted video signal is obtained from the digital broadcasting, or is transmitted from the external apparatus 3, an amount of noise contained in the inputted video signal concerned is excessively less. However, when the inputted video signal is obtained from the analog broadcasting, much noise is contained in the inputted video signal in some cases. In particular, when the electric field strength of the inputted video signal is weak, the rate of the noise increases.

FIG. 6C shows a situation in which it is judged that the inputted video signal obtained from the analog broadcasting is one for which no 2:3 pull-down processing is previously executed, and FIG. 6D shows a situation in which it is judged that the inputted video signal obtained from the analog broadcasting is one for which the 2:3 pull-down processing is previously executed. Each of the inputted video signals shown in FIGS. 6C and 6D, respectively, is mixed with the noise.

For this reason, even when the preceding field and the subsequent field are compared with each other in order to detect a change between the fields, whether or not the inputted video signal is one for which the 2:3 pull-down processing is executed in advance cannot be necessarily and exactly judged.

For example, referring to FIG. 6C, even the retrieval for the time period (t1) for the same 8 fields as those shown in FIG. 6A results in that it cannot be necessarily judged that these fields are combined in the form of “2-2-2-2”. In addition, referring to FIG. 6D, even the retrieval for the time period (t2) for the same 10 fields as those shown in FIG. 6B results in that it cannot be necessarily judged that these fields are combined in the form of “2-3-2-3”.

Thus, when the misjudgment is made, the misdetection is caused accordingly. As a result, the degradation of the image quality such as “the dropping frames” or “the aliasing” is caused.

Then, the detection precision must be further enhanced when the inputted video signal is obtained from the analog broadcasting than when the inputted video signal is obtained from the digital broadcasting or is transmitted from the external apparatus 3. In order to enhance the detection precision, the setting for the detection condition is changed from the normal case. Specifically, the changing of the time period required for the detection, the changing of the detection sensitivity, or the like is given as the changing of the setting for the detection condition.

### (Video Signal Processing in First Embodiment)

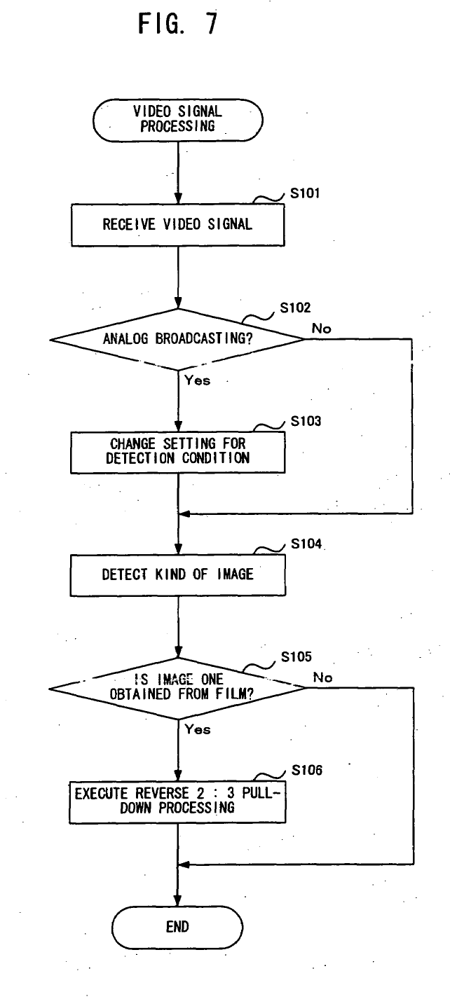

Next, a description will now be given with respect to video signal processing executed in the television receiving apparatus 1 according to the first embodiment of the invention with reference to a flow chart shown in FIG. 7.

FIG. 7 is a flow chart showing an operation when the television receiving apparatus 1 receives the video signal, and executes video signal processing for the video signal thus received.

Firstly, the video signal-switching circuit 11 receives a video signal (Step S101). When the video signal-switching circuit 11 receives the video signal, the input signal-detecting circuit 12 judges whether or not the video signal concerned is obtained from the analog broadcasting (Step S102).

When the input signal-detecting circuit 12 judges that the video signal concerned is obtained from the analog broadcasting (S102: Yes), the control circuit 13 changes the setting for the detection condition under which the kind of the video signal is automatically detected to suitable one (Step S103). In changing the setting for the detection condition, the video signal-processing circuit 14 acquires information such as a set value from the memory 15. On the other hand, when the input signal-detecting circuit 12 judges that the video signal concerned is obtained not from the analog broadcasting, but from the digital broadcasting or the external apparatus 3 (S102: No), the control circuit 13 does not change the setting for the detection condition.

Next, the video signal-processing circuit 14 detects the kind of the video signal (Step S104). Also, the kind-of-video signal-detecting circuit 14a judges whether or not the detection result shows that the video signal is one obtained from a film for which the 2:3 pull-down processing is executed in advance (Step S105).

When the kind-of-video signal-detecting circuit 14a judges that the video signal concerted is one obtained from the film (S105: Yes), the video signal-converting circuit 14b executes the reverse 2:3 pull-down processing (Step S106). On the other hand, when the kind-of-video signal-detecting circuit 14a judges that the video signal concerted is not one obtained from the film (S105: No), the video signal-converting circuit 14b does not execute the reverse 2:3 pull-down processing.

### (Effects of First Embodiment)

According to the above-mentioned first embodiment of the invention, the television receiving apparatus 1 includes the input signal-detecting circuit 12 and the control circuit 13, which results in that the setting for the detection condition under which the kind of the video signal is automatically detected can be changed to suitable one in accordance with the result on the judgment relating to whether the video signal is obtained from the analog broadcasting or the digital broadcasting, and thus the misdetection due to the judgment relating to whether or not the inputted video signal is one for which the 2:3 pull-down-processing is executed in advance can be made to be hardly caused.

### Second Embodiment

### (Configuration of Television Receiving Apparatus)

A television receiving apparatus according to a second embodiment of the invention is such that the setting for the detection condition under which a kind of the inputted video signal is detected is changed to suitable one in accordance with selection made by a user.

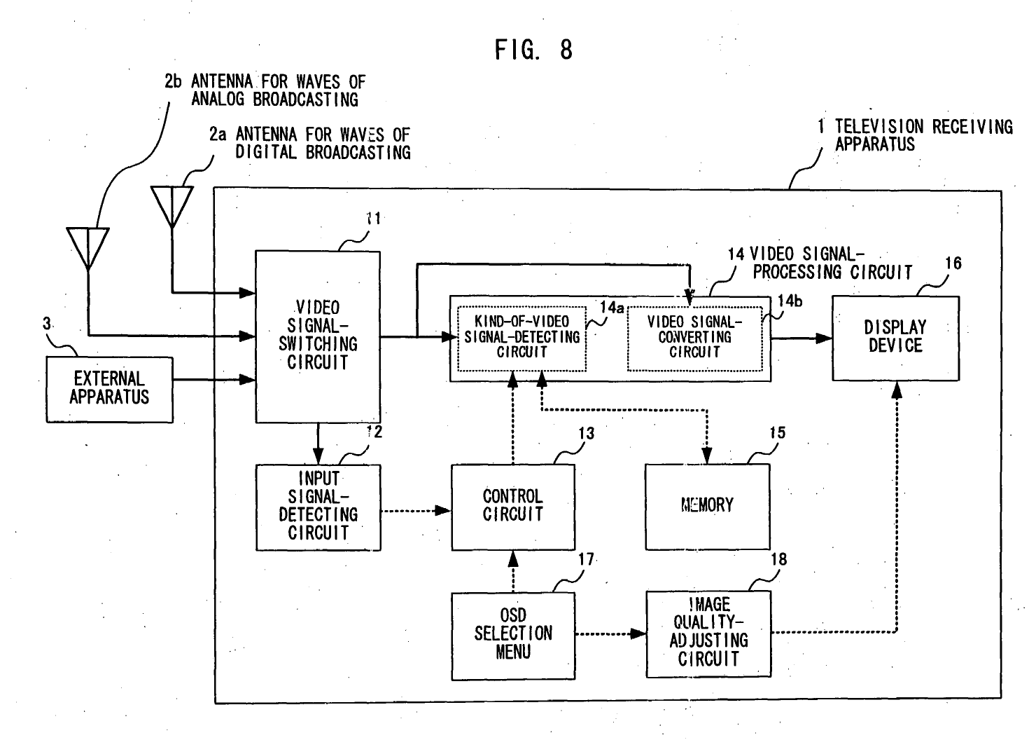

FIG. 8 is a block diagram showing an internal configuration of a television receiving apparatus according to the second embodiment of the invention.

The television receiving apparatus 1 includes a video signal-switching circuit 11, an input signal-detecting circuit 12, a control circuit 13, a video signal-processing circuit 14, a memory 15, a display device 16, an OSD selection menu 17, and an image adjusting circuit 18. In addition, a digital antenna 2a, an analog antenna 2b, and an external apparatus 3 are connected from the outside to the television receiving apparatus 1.

The video signal-switching circuit 11, the input signal-detecting circuit 12, the control circuit 13, the video signal-processing circuit 14, the memory 15, and the display device 16 are the same as those in the television receiving apparatus 1 of the first embodiment described above.

The OSD selection menu 17 is one with which the user performs the setting about the image display made on the display device 16 in accordance with the contents displayed on the screen.

The image adjusting circuit 18 adjusts an image quality for the image displayed on the display device 16 in accordance with the item selected from the OSD selection menu 17.

### (OSD Display Menu)

Next, a description will now be given with respect to an operation for changing the setting for the detection condition under which a kind of the inputted video signal is detected to suitable one by using the OSD selection menu 17.

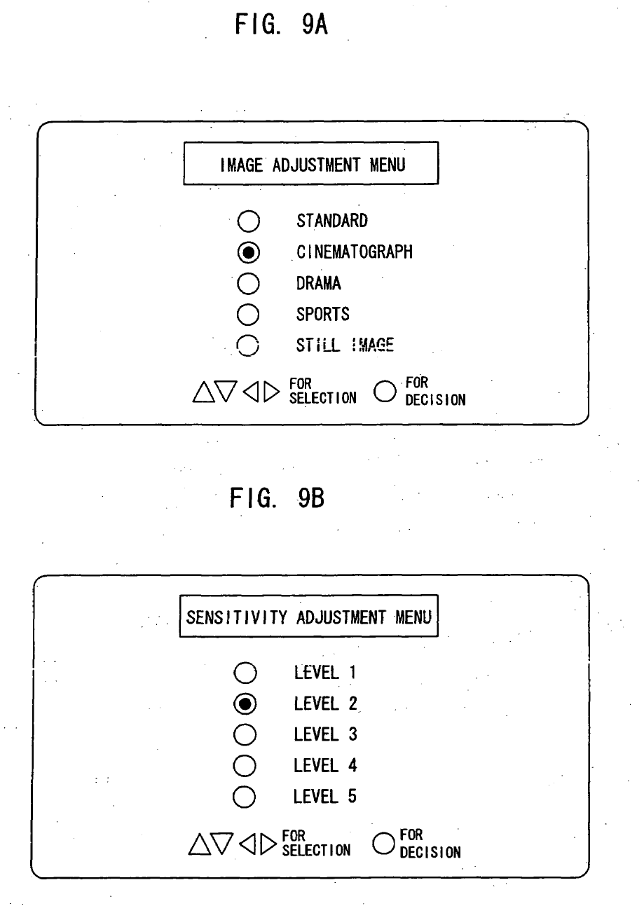

FIGS. 9A and 9B are respectively display examples of an image selection menu in the OSD selection menu 17 of the television receiving apparatus 1 according to the second embodiment of the invention.

The television receiving apparatus 1 has a function of adjusting a shade of color or the like of the displayed image. Thus, the user can adjust the shade of color of the image displayed on the display device 16 through the OSD selection menu 17 displayed on the screen and the image adjusting circuit 18. FIG. 9A is a display example of an image adjustment menu with which the shade of color of the image is adjusted to the most suitable one in accordance with the kind of the image displayed on the screen.

When the shade of color is adjusted by the OSD selection menu 17 and the image adjusting circuit 18, the television receiving apparatus 1 according to the second embodiment of the invention can change altogether the setting for the detection condition under which the kind of the inputted video signal is detected to suitable one.

Referring to FIG. 9A, for example, five items consisting of “STANDARD”, “CINEMATOGRAPH”, “DRAMA”, “SPORTS”, and “STILL IMAGE” are displayed as the choices. The user selects desired one among these choices by using a remocon device or the like while referring to these choices.

Here, when the user selects “CINEMATOGRAPH” among the choices illustrated in FIG. 9A, the possibility that the user desires to enjoy an image obtained from a film is high.

Only when the user selects “CINEMATOGRAPH” among them, the detection condition is set so that the inputted video signal for which the 2:3 pull-down processing is executed in advance becomes easy to detect. On the other hand, when the user selects any one other than “CINEMATOGRAPH” among them, the detection condition is set so that the inputted video signal for which the 2:3 pull-down processing is executed in advance becomes hard to detect.

In addition, FIG. 9B is a display example of a set picture when the user directly sets desired one of levels for the detection condition under which the kind of the inputted video signal is detected.

Levels (five levels in FIG. 9B) for the detection condition under which the kind of the inputted video signal is detected are displayed on the screen. When the user selects desired one for the detection condition among these five levels, the detection condition corresponding to the desired level thus selected is set.

### (Video Signal Processing in Second Embodiment)

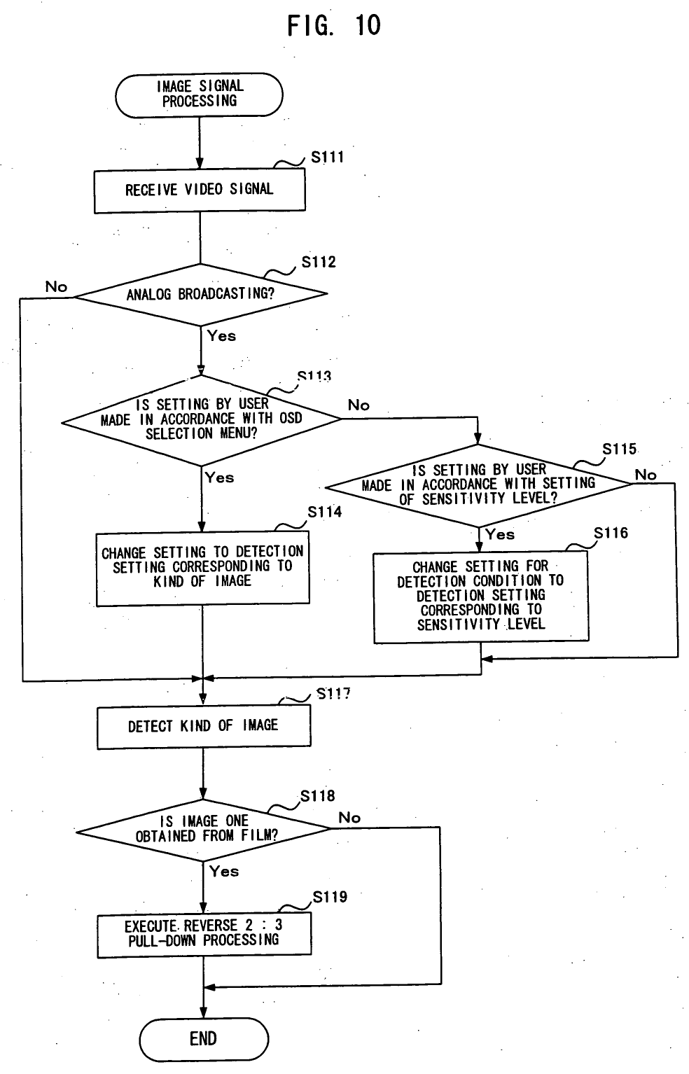

Next, a description will now be given with respect to video signal processing executed in the television receiving apparatus 1 according to the second embodiment of the invention with reference to a flow chart shown in FIG. 10.

FIG. 10 is a flow chart showing an operation when the television receiving apparatus 1 receives a video signal and executes video signal processing for the video signal thus received.

Firstly, the video signal-switching circuit 11 receives a video signal (Step S111). When the video signal-switching circuit 11 receives the video signal, the input signal-detecting circuit 12 judges whether or not the video signal concerned is obtained from the analog broadcasting (Step S112).

When the input signal-detecting circuit 12 judges that the video signal concerned is obtained from the analog broadcasting (S112: Yes), the control circuit 13 judges whether or not the change of the setting, for the detection condition under which the kind of the video signal is detected, by the user is made in accordance with the OSD selection menu 17 (Step S113).

When judging that the change of the setting, for the detection condition under which the kind of the video signal is detected, by the user is made in accordance with the OSD selection menu 17 (S113: Yes), the control circuit 13 changes the setting to suitable one for the detection condition which is selected from the OSD selection menu 17 and which corresponds to the kind of the video signal (Step S114). In changing the setting, the video signal-processing circuit 14 receives a necessary signal from the control circuit 13, and acquires a set value which is selected from the OSD selection menu 17 and which corresponds to the kind of the inputted video signal from the memory 15. On the other hand, when judging that the change of the setting by the user is not made in accordance with the OSD selection menu 17 (S113: No), the control circuit 13 judges whether or not the change of the setting for the detection condition is made in accordance with the setting of the detection sensitivity level (Step S115).

When judging that the change of the setting for the detection condition is made in accordance with the setting of the detection sensitivity level (S115: Yes), the control circuit 13 changes the setting for the detection condition to suitable one corresponding to the sensitivity level concerned (Step S116).

On the other hand, when the input signal-detecting circuit 12 judges that the inputted video signal is obtained not from the analog broadcasting, but from the digital broadcasting or the external apparatus 3 (S112: No), and also when the control circuit 13 judges that no change of the setting for the detection condition is made in accordance with the setting of the detection sensitivity level (S115: No), the control circuit 13 does not change the setting for the detection condition.

Next, the kind-of-video signal-detecting circuit 14a detects the kind of the inputted video signal (Step S117). Also, the kind-of-video signal-detecting circuit 14a judges whether or not the detection result shows that the inputted video signal is one, obtained from a film, for which the 2:3 pull-down processing is executed in advance (Step S118).

When the kind-of-video signal-detecting circuit 14a judges the detection result shows that the inputted video signal is one, obtained from the film, for which the 2:3 pull-down processing is executed in advance (S118: Yes), the video signal-converting circuit 14b executes the reverse 2:3 pull-down processing (Step S119). On the other hand, when the kind-of-video signal-detecting circuit 14a judges that the detection result does not show that the inputted video signal is one, obtained from the film, for which the 2:3 pull-down processing is executed in advance (S118: No), the video signal-converting circuit 14b does not execute the reverse 2:3 pull-down processing.

### (Effects of Second Embodiment)

According to the above-mentioned second embodiment of the invention, the television receiving apparatus 1 includes the OSD selection menu 17, and stores the set values, for the detection conditions, corresponding to the kinds of the shades of color, respectively, are stored in the memory 15 in advance, which results in that it is possible to determine the setting for suitable one of the detection conditions optimized in correspondence to the kinds of the adjustment for the shades of color, respectively.

In addition, the user can set the detection sensitivity level, which results in that the detection condition optimal for the video signal can be manually determined.

Note that, when the still image is selected in the adjustment for the shade of color, it is thought that an apparatus such as a digital camera may be connected as the external apparatus 3 to the television receiving apparatus 1. Thus, although a video signal is inputted in the form of an analog signal, since the inputted video signal is not one for which the 2:3 pull-down processing is executed in advance, this effect may be directly inputted to the kind-of-video signal-detecting circuit 14a. As a result, the detection of the kind of the video signal can be skipped.

It should be noted that the present invention is not limited to the embodiments described above, and the various combinations and changes may be made without departing from or changing the technical idea of the present invention.

What is claimed is:

1. A television receiving apparatus, comprising:
a receiving portion for receiving a video signal;
a first judging portion for judging whether the video signal is an analog signal or a digital signal;
a second judging portion for judging whether the video signal is a signal for which 2:3 pull-down processing is executed; and
a control portion for changing a setting for a judgment condition in the second judging portion in accordance with a judgment result obtained from the first judging portion.

2. A television receiving apparatus according to claim 1, wherein the control portion changes a time period required for detection as the setting for the judgment condition in the second judging portion.

3. A television receiving apparatus according to claim 1, wherein the control portion changes detection sensitivity as the setting for the judgment condition in the second judging portion.

4. A television receiving apparatus according to claim 1, wherein the first judging portion judges each of an analog broadcasting wave and an analog input from an outside as the analog signal.

5. A television receiving apparatus according to claim 1, wherein when the first judging portion judges the video signal as the analog signal, the control portion changes the judgment condition in the second judging portion to a more precise judgment condition.

6. A television receiving apparatus, comprising:
a receiving portion for receiving a video signal;
a first judging portion for judging whether the video signal is an analog signal or a digital signal;
a second judging portion for judging whether the video signal is a signal for which 2:3 pull-down processing is executed;
a video signal-converting portion for, when the second judging portion judges that the video signal is a signal for which the 2:3 pull-down processing is executed, executing reverse 2:3 pull-down processing for the video signal; and
a control portion for changing a setting for a judgment condition in the second judging portion in accordance with a judgment result obtained from the first judging portion.

7. A television receiving apparatus according to claim 6, wherein the control portion changes a time period required for detection as the setting for the judgment condition in the second judging portion.

8. A television receiving apparatus according to claim 6, wherein the control portion changes detection sensitivity as the setting for the judgment condition in the second judging portion.

9. A television receiving apparatus according to claim 6, wherein the first judging portion judges each of an analog broadcasting wave and an analog input from an outside as the analog signal.

10. A television receiving apparatus according to claim 6, wherein when the first judging portion judges the video signal as the analog signal, the control portion changes the judgment condition in the second judging portion to a more precise judgment condition.

11. A television receiving apparatus, comprising:
a receiving portion for receiving a video signal;
a first judging portion for judging whether the video signal is an analog signal or a digital signal;
a second judging portion for judging whether the video signal is a signal for which 2:3 pull-down processing is executed;
an image quality-adjusting portion for performing display adjustment for an image quality in accordance with selection made by a user; and
a control portion for changing a setting for a judgment condition obtained from the second judging portion in accordance with a judgment result obtained from the first judging portion and the display adjustment for an image quality made by the image quality-adjusting portion.

12. A television receiving apparatus according to claim 11, wherein the control portion changes a time period required for detection as the setting for the judgment condition in the second judging portion.

13. A television receiving apparatus according to claim 11, wherein the control portion changes detection sensitivity as the setting for the judgment condition in the second judging portion.

14. A television receiving apparatus according to claim 11, wherein the first judging portion judges each of an analog broadcasting wave and an analog input from an outside as the analog signal.

15. A television receiving apparatus according to claim 11, wherein the image quality-adjusting portion has a plurality of predetermined set values for the display adjustment.

16. A television receiving apparatus according to claim 15, wherein when the image quality-adjusting portion selects the set value, about a film, for the display adjustment, the control portion changes the adjustment condition in the second judging portion to a more precise judgment condition.

17. A television receiving apparatus according to claim 15, wherein when the image quality-adjusting portion selects the set value, about a still image, for the display adjustment, the control portion instructs the second judging portion to judge that the video signal is not a signal for which the 2:3 pull-down processing is executed.

18. A television receiving apparatus according to claim 11, wherein the image quality-adjusting portion is adapted to directly change the set value for the judgment condition in the second judging portion.

19. A television receiving apparatus according to claim 11, wherein when the first judging portion judges the video signal as the analog signal, the control portion changes the judgment condition in the second judging portion to a more precise judgment condition.
